(19) United States
(12) Patent Application Publication
(10) Pub. No.: US 2013/0002860 A1
(43) Pub. Date: Jan. 3, 2013

(54) INFORMATION ACQUIRING DEVICE AND OBJECT DETECTING DEVICE

(75) Inventors: Atsushi YAMAGUCHI, Ibi-Gun (JP); Nobuo IWATSUKI, Anpachi-Gun (JP)

(73) Assignee: Sanyo Electric Co., Ltd., Moriguchi-shi (JP)

(21) Appl. No.: 13/616,611

(22) Filed: Sep. 14, 2012

Related U.S. Application Data
(63) Continuation of application No. PCT/JP2012/059449, filed on Apr. 6, 2012.

(30) Foreign Application Priority Data
Apr. 28, 2011 (JP) 2011-101666

(51) Int. Cl. H04N 7/18

(52) U.S. Cl. 348/135; 348/E07.085

(57) ABSTRACT

An information acquiring device is provided with a projection optical system which projects laser light onto a target area with a predetermined dot pattern, and a light receiving optical system which captures an image of the target area. Segment areas are set on a reference dot pattern reflected on a reference plane and captured by the light receiving optical system. A distance to each segment area is acquired by matching between a dot pattern captured at the time of distance measurement and dots in each segment area. The segment area sizes differ depending on regions of the reference dot pattern.

This application claims priority under 35 U.S.C. Section 119 of Japanese Patent Application No. 2011-101666 filed on Apr. 28, 2011, entitled “INFORMATION ACQUIRING DEVICE AND OBJECT DETECTING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive reflected light of laser light having a dot pattern from the target area by a light receiving element. Then, a distance to each portion of an object to be detected (an irradiation position of each dot on an object to be detected) is detected, based on a light receiving position of each dot on the light receiving element, using a triangulation method (see e.g. pp. 1279-1280, the 19th Annual Conference Proceedings (Sep. 18-20, 2001) by the Robotics Society of Japan).

In the object detecting device thus constructed, distance detection is performed by comparing between a dot pattern to be received by a photodetector when a reference plane is disposed at a position away from the object detecting device by a predetermined distance, and a dot pattern to be received by the photodetector at the time of actual measurement. For instance, a plurality of areas each having a predetermined size are set on a dot pattern with respect to the reference plane. The object detecting device detects a distance to an object to be detected for each of the areas, based on determination at which position on the dot pattern received at the time of actual measurement, dots to be included in each area are located.

In the above arrangement, as the size of an area to be set on the dot pattern increases, the distance detection precision is enhanced. However, there is a problem that an increase in the area size increases the processing amount required for comparing/matching between dots in each area and the dot pattern at the time of actual measurement.

### SUMMARY OF THE INVENTION

A first aspect of the invention is directed to an information acquiring device for acquiring information on a target area using light. The information acquiring device according to the first aspect includes a projection optical system which projects laser light onto the target area with a predetermined dot pattern; a light receiving optical system which is aligned with the projection optical system away from the projection optical system by a predetermined distance, and captures an image of the target area; and a distance acquiring section which acquires a distance to each portion of an object in the target area, based on the dot pattern captured by the light receiving optical system. In this arrangement, the distance acquiring section sets segment areas in a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area. Sizes of the segment areas are set in such a manner that the segment area sizes differ depending on regions of the reference dot pattern.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIG. 3 is a perspective view showing an installation state of a projection optical system and a light receiving optical system in the embodiment.

FIG. 4 is a diagram schematically showing an arrangement of the projection optical system and the light receiving optical system in the embodiment.

FIG. 5A is a diagram schematically showing an irradiation state of laser light onto a target area in the embodiment, and FIG. 5B is a diagram schematically showing a light receiving state of laser light on a CMOS image sensor in the embodiment.

FIGS. 6A through 6C are diagrams for describing a reference template generating method in the embodiment.

FIGS. 7A through 7C are diagrams for describing a method for detecting a shift position of a segment area of a reference template at the time of actual measurement in the embodiment.

FIGS. 8A through 8D are diagrams showing a verification result about distance detection precision in the case where all segment areas are set to have the same size as each other.

FIGS. 9A and 9B are schematic diagrams showing segment area sizes to be set for a reference pattern area in the embodiment, and FIGS. 9C and 9D are diagrams for describing a segment area setting method in the embodiment.

FIG. 10A is a flowchart showing a dot pattern setting processing with respect to segment areas in the embodiment, and FIG. 10B is a flowchart showing a distance detection processing to be performed at the time of actual measurement in the embodiment.

FIGS. 11A and 11C are schematic diagrams showing a segment area size setting method in a modification example, and FIG. 11B is a diagram schematically showing detection distance information for use in determining a moving amount of an object to be detected in the modification example.

FIG. 12 is a flowchart showing a segment area re-setting processing in the modification example.

FIGS. 13A through 13D are schematic diagrams each showing segment area size setting methods in other modification examples.

FIG. 14 is a schematic diagram showing a segment area size setting method in another modification example.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, a CPU 21 (a three-dimensional distance calculator 21b) and an image signal processing circuit 23 correspond to a “distance acquiring section” in the claims. A DOE 114 corresponds to a “diffractive optical element” in the claims. An imaging lens 122 corresponds to a “condensing lens” in the claims. A CMOS image sensor 123 corresponds to an “image sensor” in the claims. The description regarding the correspondence between the claims and the embodiment is merely an example, and the claims are not limited by the description of the embodiment.

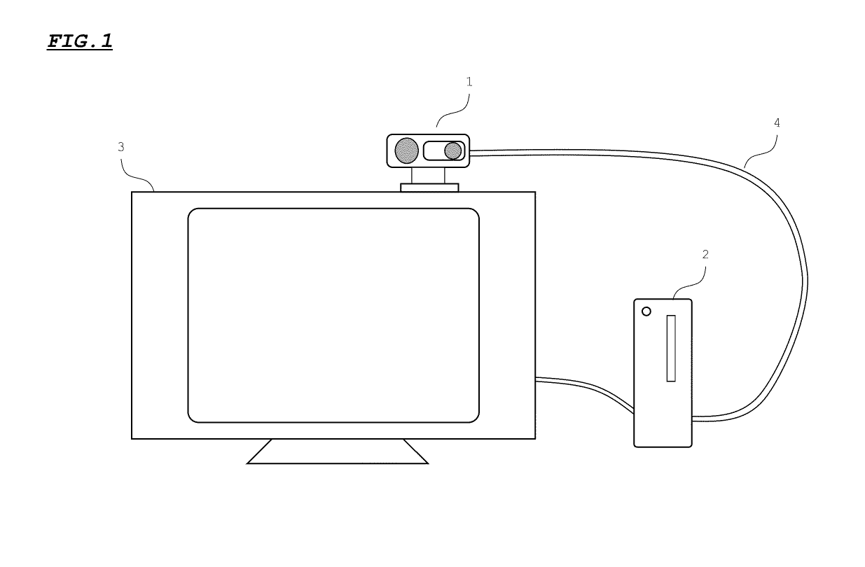

A schematic arrangement of an object detecting device according to the first embodiment is described. As shown in FIG. 1, the object detecting device is provided with an information acquiring device 1, and an information processing device 2. A TV 3 is controlled by a signal from the information processing device 2. A device constituted of the information acquiring device 1 and the information processing device 2 corresponds to an object detecting device of the invention.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

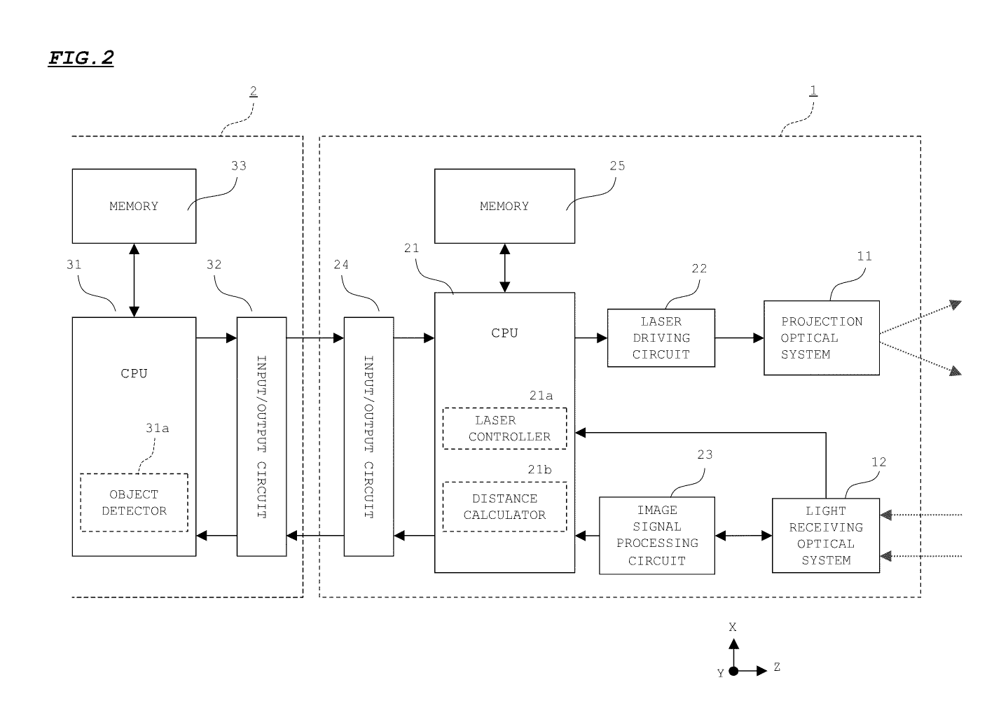

FIG. 2 is a diagram showing an arrangement of the information acquiring device 1 and the information processing device 2.

The information acquiring device 1 is provided with a projection optical system 11 and a light receiving optical system 12, which constitute an optical section. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

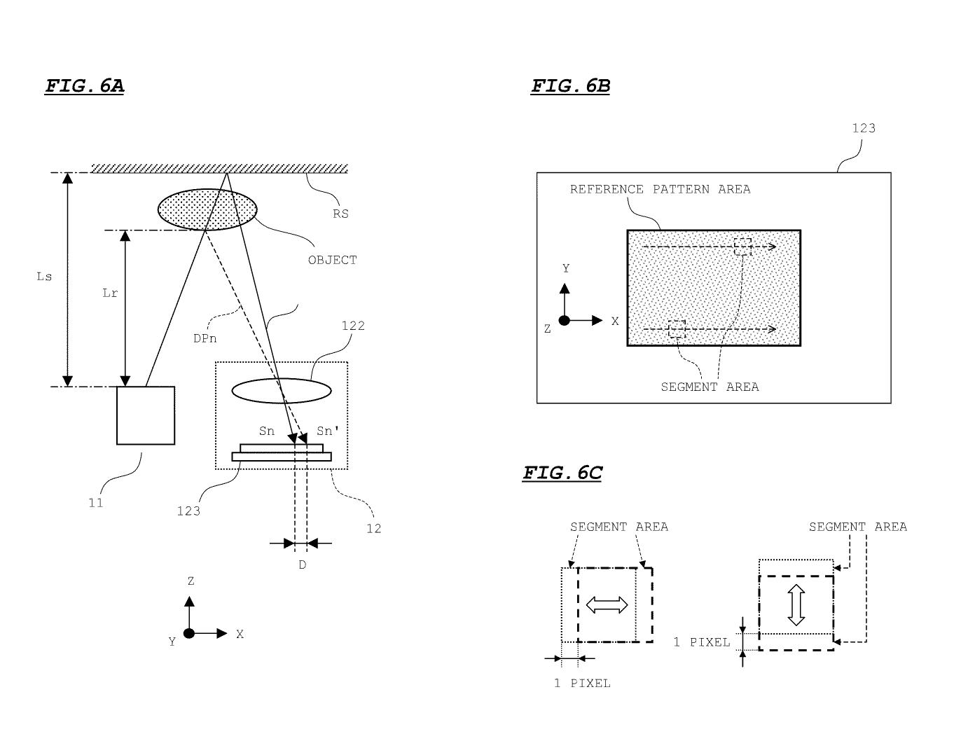

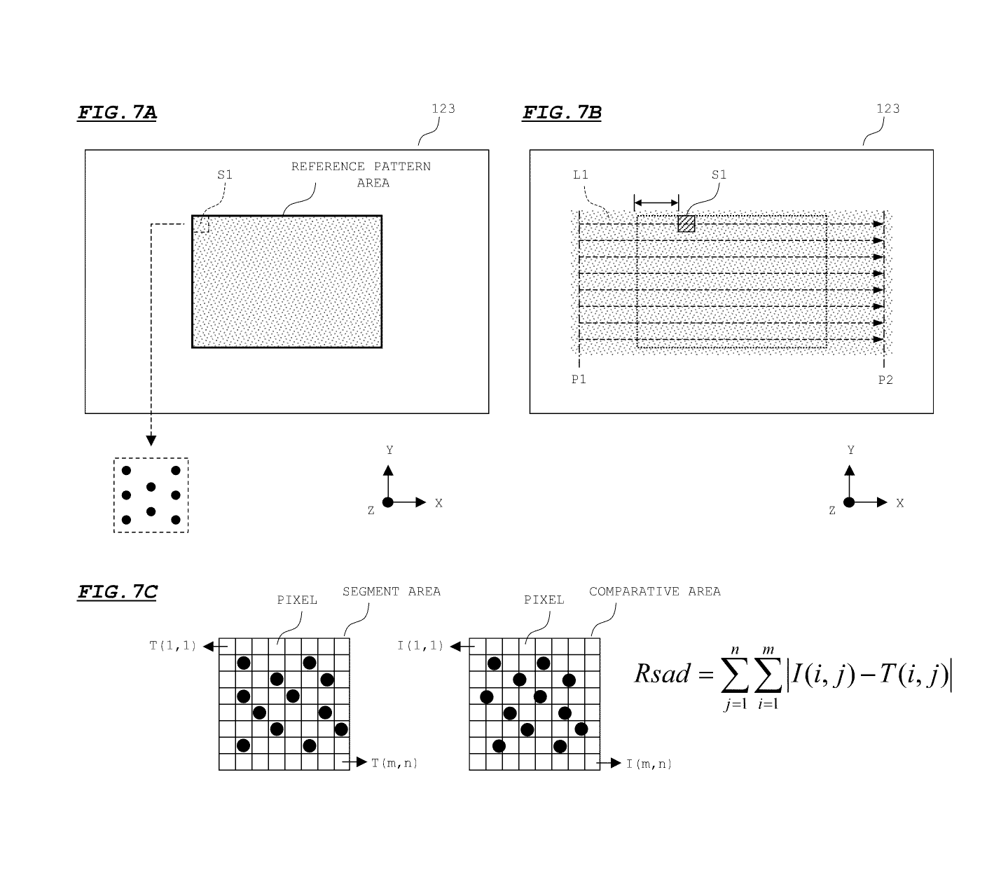

The projection optical system 11 irradiates a target area with laser light having a predetermined dot pattern. The light receiving optical system 12 receives laser light reflected on the target area. The arrangement of the projection optical system 11 and the light receiving optical system 12 will be described later referring to FIGS. 6 and 7.

The CPU 21 controls the parts of the information acquiring device 1 in accordance with a control program stored in the memory 25. By the control program, the CPU 21 has functions of a laser controller 21a for controlling the laser light source 111 (to be described later) in the projection optical system and a three-dimensional distance calculator 21b for generating three-dimensional distance information.

The laser driving circuit 22 drives the laser light source 111 (to be described later) in accordance with a control signal from the CPU 21. The image signal processing circuit 23 controls the CMOS image sensor 123 (to be described later) in the light receiving optical system 12 to successively read signals (electric charges) from the pixels, which have been generated in the CMOS image sensor 123, line by line. Then, the image signal processing circuit 23 outputs the read signals successively to the CPU 21.

The CPU 21 calculates a distance from the information acquiring device 1 to each portion of an object to be detected, by a processing to be implemented by the three-dimensional distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

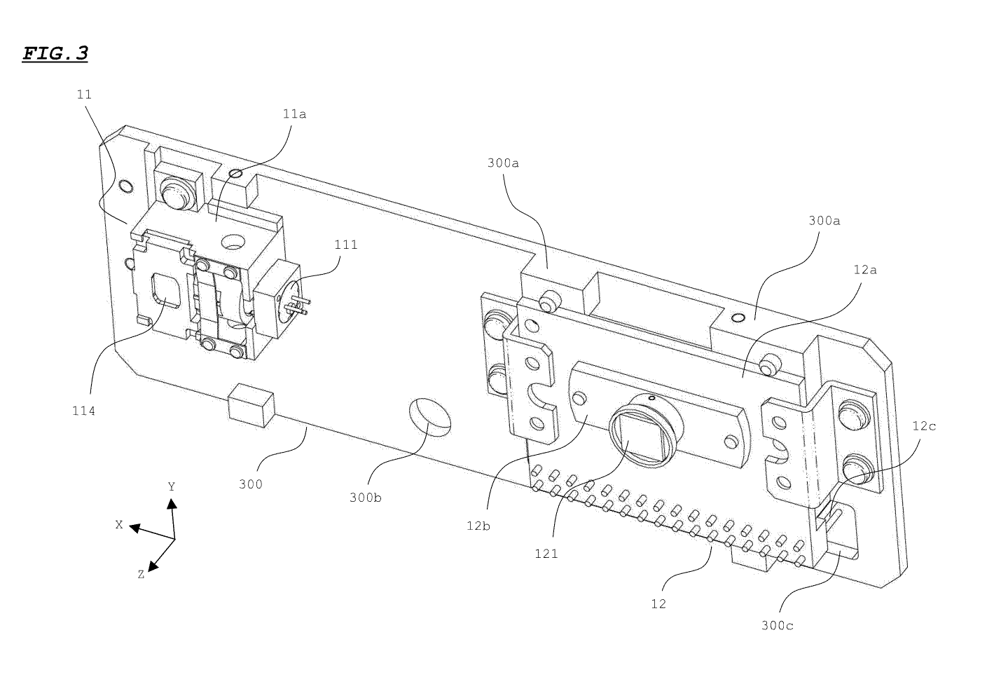

FIG. 3 is a perspective view showing an installation state of the projection optical system 11 and the light receiving optical system 12.

The projection optical system 11 and the light receiving optical system 12 are mounted on a base plate 300 having a high heat conductivity. The optical members constituting the projection optical system 11 are mounted on a chassis 11a. The chassis 11a is mounted on the base plate 300. With this arrangement, the projection optical system 11 is mounted on the base plate 300.

The light receiving optical system 12 is mounted on top surfaces of two base blocks 300a on the base plate 300, and on a top surface of the base plate 300 between the two base blocks 300a. The CMOS image sensor 123 to be described later is mounted on the top surface of the base plate 300 between the base blocks 300a. A holding plate 12a is mounted on the top surfaces of the base blocks 300a. A lens holder 12b for holding a filter 121 and an imaging lens 122 to be described later is mounted on the holding plate 12a.

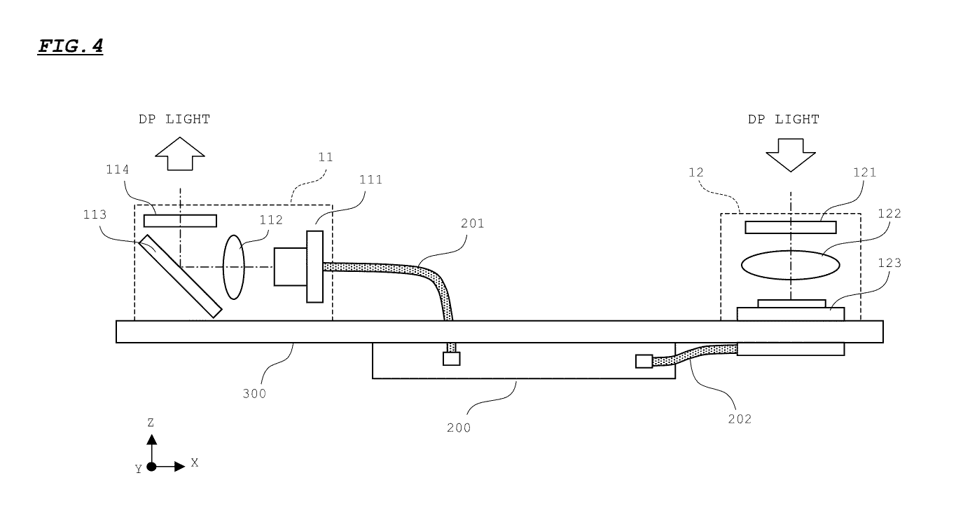

The projection optical system 11 and the light receiving optical system 12 are aligned in X-axis direction away from each other with a predetermined distance in such a manner that the projection center of the projection optical system 11 and the imaging center of the light receiving optical system 12 are linearly aligned in parallel to X-axis. A circuit board 200 (see FIG. 4) for holding the circuit section (see FIG. 2) of the information acquiring device 1 is mounted on the back surface of the base plate 300.

A hole 300b is formed in the center of a lower portion of the base plate 300 for taking out a wiring of a laser light source 111 from a back portion of the base plate 300. Further, an opening 300c for exposing a connector 12c of the CMOS image sensor 123 from the back portion of the base plate 300 is formed in the lower portion of the base plate 300 where the light receiving optical system 12 is installed.

FIG. 4 is a diagram schematically showing an arrangement of the projection optical system 11 and the light receiving optical system 12 in the embodiment.

The projection optical system 11 is provided with the laser light source 111, a collimator lens 112, a rise-up mirror 113, and a DOE (Diffractive Optical Element) 114. Further, the light receiving optical system 12 is provided with the filter 121, the imaging lens 122, and the CMOS image sensor 123.

The laser light source 111 outputs laser light of a narrow wavelength band of or about 830 nm. The laser light source 111 is disposed in such a manner that the optical axis of laser light is aligned in parallel to X-axis. The collimator lens 112 converts the laser light emitted from the laser light source 111 into substantially parallel light. The collimator lens 112 is disposed in such a manner that the optical axis thereof is aligned with the optical axis of laser light emitted from the laser light source 111. The rise-up mirror 113 reflects laser light entered from the collimator lens 112 side. The optical axis of laser light is bent by 90° by the rise-up mirror 113 and is aligned in parallel to Z-axis.

The DOE 114 has a diffraction pattern on a light incident surface thereof. The diffraction pattern is formed by e.g. step-type hologram. Laser light reflected on the rise-up mirror 113 and entered to the DOE 114 is converted into laser light having a dot pattern by a diffractive action of the diffraction pattern, and is irradiated onto a target area. The diffraction pattern is designed to have a predetermined dot pattern in a target area.

There is disposed an aperture (not shown) for forming the shape of laser light into a circular shape between the laser light source 111 and the collimator lens 112. The aperture may be formed by an emission opening of the laser light source 111.

Laser light reflected on the target area is entered to the imaging lens 122 through the filter 121.

The filter 121 transmits light of a wavelength band including the emission wavelength (of or about 830 nm) of the laser light source 111, and blocks light of the other wavelength band. The imaging lens 122 condenses light entered through the filter 121 on the CMOS image sensor 123. The imaging lens 122 is constituted of plural lenses, and an aperture and a spacer are interposed between a lens and another lens of the imaging lens 122. The aperture limits external light to be in conformity with the F-number of the imaging lens 122.

The CMOS image sensor 123 receives light condensed on the imaging lens 122, and outputs a signal (electric charge) in accordance with a received light amount to the image signal processing circuit 23 pixel by pixel. In this example, the CMOS image sensor 123 is configured to perform high-speed signal output so that a signal (electric charge) of each pixel can be outputted to the image signal processing circuit 23 with a high response from a light receiving timing at each of the pixels.

The filter 121 is disposed in such a manner that the light receiving surface thereof extends perpendicular to Z-axis. The imaging lens 122 is disposed in such a manner that the optical axis thereof extends in parallel to Z-axis. The CMOS image sensor 123 is disposed in such a manner that the light receiving surface thereof extends perpendicular to Z-axis. Further, the filter 121, the imaging lens 122 and the CMOS image sensor 123 are disposed in such a manner that the center of the filter 121 and the center of the light receiving area of the CMOS image sensor 123 are aligned on the optical axis of the imaging lens 122.

As described above referring to FIG. 3, the projection optical system 11 and the light receiving optical system 12 are mounted on the base plate 300. Further, the circuit board 200 is mounted on the lower surface of the base plate 300, and wirings (flexible substrates) 201 and 202 are connected from the circuit board 200 to the laser light source 111 and to the CMOS image sensor 123. The circuit section of the information acquiring device 1 such as the CPU 21 and the laser driving circuit 22 shown in FIG. 2 is mounted on the circuit board 200.

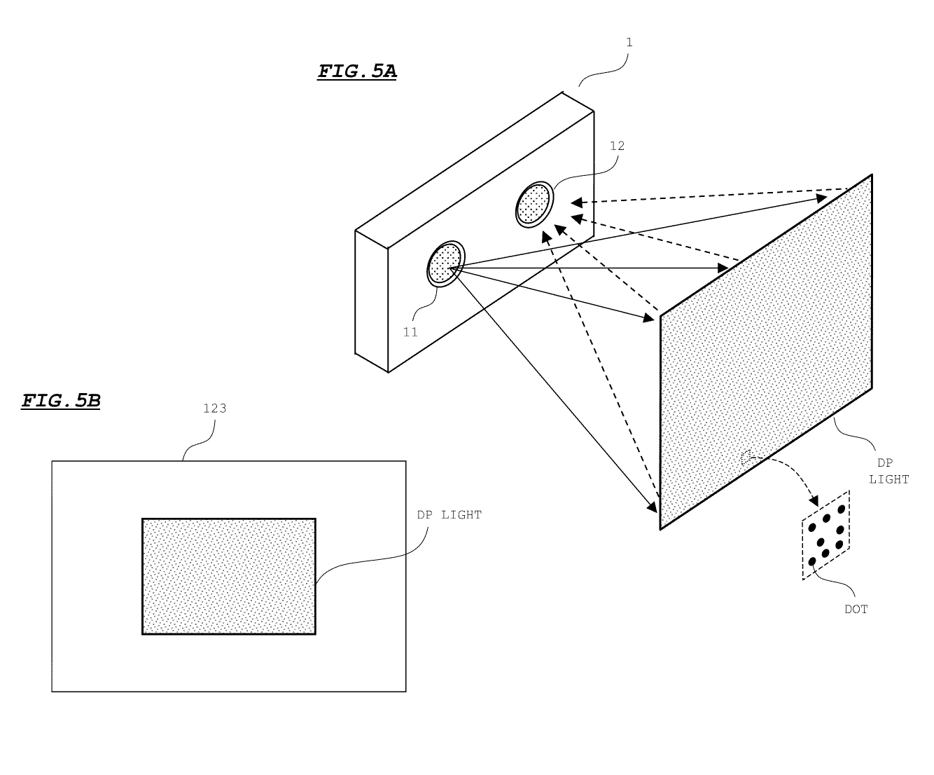

FIG. 5A is a diagram schematically showing an irradiation state of laser light onto a target area. FIG. 5B is a diagram schematically showing a light receiving state of laser light on the CMOS image sensor 123. To simplify the description, FIG. 5B shows a light receiving state in the case where a flat plane (screen) is disposed on a target area.

As shown in FIG. 5A, the projection optical system 11 irradiates laser light having a dot pattern (hereinafter, the entirety of the laser light having the dot pattern is called as “DP light”) toward a target area. FIG. 5A shows a projection area of DP light by a solid-line frame. In the light flux of DP light, dot areas (hereinafter, simply called as “dots”) in which the intensity of laser light is increased by a diffractive action of the diffractive optical element locally appear in accordance with the dot pattern by the diffractive action of the DOE 114. In the case where a flat plane (screen) is disposed in a target area, DP light reflected on the flat plane is distributed on the CMOS image sensor 123, as shown in FIG. 5B.

In this section, a reference pattern for use in distance detection is described referring to FIGS. 6A and 6B.

Referring to FIG. 6A, at the time of generating a reference pattern, a reflection plane RS perpendicular to Z-axis direction is disposed at a position away from the projection optical system 11 by a predetermined distance Ls. The temperature of the laser light source 111 is retained at a predetermined temperature (reference temperature). Then, DP light is emitted from the projection optical system 11 for a predetermined time Te in the above state. The emitted DP light is reflected on the reflection plane RS, and is entered to the CMOS image sensor 123 in the light receiving optical system 12. By performing the above operation, an electrical signal at each pixel is outputted from the CMOS image sensor 123. The value (pixel value) of the electrical signal at each outputted pixel is expanded in the memory 25 shown in FIG. 2.

As shown in FIG. 6B, a reference pattern area for defining an irradiation area of DP light on the CMOS image sensor 123 is set, based on the pixel values expanded in the memory 25.

Next, segment areas (comparative example) to be set in a reference pattern area are described referring to FIGS. 6B and 6C.

In the comparative example, a plurality of segment areas is set for the reference pattern area which has been set as described above. All the segment areas have the same size as each other, and as shown in FIG. 6C, each two segment areas adjacent to each other in up and down directions or in left and right directions are set in such a manner that the each two segment areas overlap each other in a state that the segment areas are displaced from each other by one pixel. In this arrangement, since dots are locally arranged with a unique pattern in each of the segment areas, the pixel value pattern of a segment area differs in each of the segment areas. Thus, the pixel values of the pixels to be included in each segment area are assigned to the each segment area.

In this way, information relating to the position of a reference pattern area on the CMOS image sensor 123, pixel values (reference pattern) of all the pixels to be included in the reference pattern area, information relating to the segment area size (height and width), and information relating to the position of each segment area on the reference pattern area constitute a reference template. The pixel values (reference pattern) of all the pixels to be included in the reference pattern area correspond to a dot pattern of DP light to be included in the reference pattern area. Further, the pixel values of pixels to be included in each segment area are acquired by setting, to a mapping area of the pixel values (reference pattern) of all the pixels to be included in the reference pattern area, a segment area which is defined by the information relating to the segment area size and the information relating to the position of each segment area on the reference pattern area.

The reference template in the above arrangement may also hold the pixel values of pixels to be included in each segment area, for each of the segment areas in advance.

The reference template thus configured is stored in the memory 25 shown in FIG. 2 in a non-erasable manner. The reference template stored in the memory 25 is referred by the CPU 21 to in calculating a distance from the projection optical system 11 to each portion of an object to be detected.

For instance, in the case where an object is located at a position nearer to the distance Ls shown in FIG. 6A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 6A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above. The details of the calculation method is disclosed in e.g. pp. 1279-1280, the 19th Annual Conference Proceedings (Sep. 18-20, 2001) by the Robotics Society of Japan.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 123 at the time of actual measurement, and a dot pattern included in the segment area Sn.

FIGS. 7A through 7C are diagrams for describing the aforementioned detection method with use of the segment areas (comparative example) shown in FIGS. 6B and 6C. FIG. 7A is a diagram showing a state as to how a reference pattern area and a segment area are set on the CMOS image sensor 123, FIG. 7B is a diagram showing a segment area searching method to be performed at the time of actual measurement, and FIG. 7C is a diagram showing a matching method between an actually measured dot pattern of DP light, and a dot pattern included in a segment area of a reference template.

For instance, in the case where a displacement position of a segment area S1 at the time of actual measurement shown in FIG. 7A is searched, as shown in FIG. 7B, the segment area S1 is fed pixel by pixel in X-axis direction in a range from P1 to P2 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference pattern area. This is because, as described above, each segment area is normally displaced only in X-axis direction from a position set by the reference template at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area, depending on the position of an object to be detected. In view of the above, the range from P1 to P2 is set wider than the X-axis directional width of the reference pattern area.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 7C, in the case where pixels of m columns by n rows are included in one segment area, there is obtained a difference between a pixel value T (i, j) of a pixel at i-th column, j-th row in the segment area, and a pixel value I (i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

The inventor of the present application performed a verification about distance detection precision by changing the segment area size to be set, in the case where all the segment areas are set to have the same size as each other, as described above.

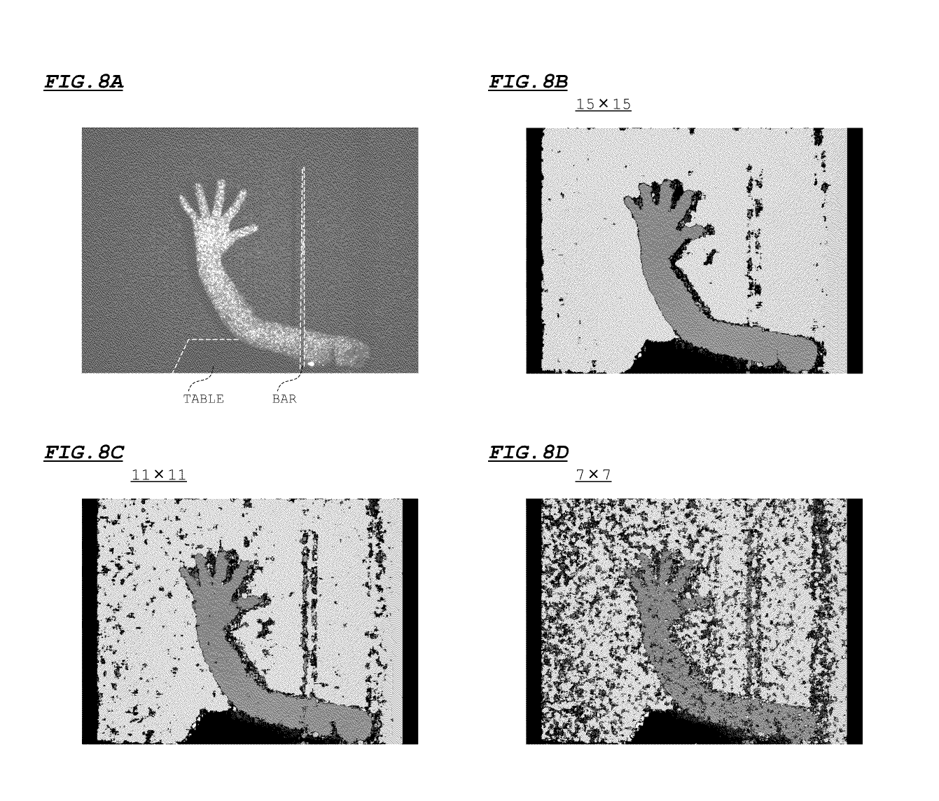

FIG. 8A is a diagram showing an image of a dummy arm which is positioned in a target area used in the present verification. To simplify the description, in FIG. 8A, regions corresponding to a table and a bar are enclosed by the white broken lines. FIGS. 8B through 8D respectively show measurement results about a distance to the object, which are obtained by changing the segment area size to 15 pixels by 15 pixels, 11 pixels by 11 pixels, and 7 pixels by 7 pixels. Referring to FIGS. 8B through 8D, the farther the measured distance is, the whiter the detected image is; and the positions of segment areas where the distance measurement failed, in other words, the positions where segment area searching failed are shown by black portions.

As shown in FIGS. 8B through 8D, as the segment area size decreases, the number of positions of segment areas where distance measurement failed increases. In FIGS. 8B through 8D, ratios (error rates) of a region where the distance could not be accurately detected with respect to the entire region are respectively, 8%, 12% and 24%. Specifically, if the segment area size is set to 15 pixels by 15 pixels or 11 pixels by 11 pixels, an increase in the error rate is suppressed, and the shape of the fingers of the dummy arm can be substantially accurately detected. On the other hand, if the segment area size is set to 7 pixels by 7 pixels, the error rate increases, and it is difficult to accurately detect the shape of the fingers of the dummy arm.

As described above, an increase in the segment area size results in a change of the distance detection precision for an object to be detected in a target area. For instance, if the surface area of a segment area increases by two times, the number of dots to be included in the segment area increases substantially by two times. Thereby, the uniqueness of a dot pattern to be included in the segment area is enhanced, which makes it easy to accurately search a shift position of the segment area. In view of this, it is desirable to set the segment area size large for enhancing the distance detection precision.

However, an increase in the segment area size results in an increase in the computation amount of the value Rsad at the time of searching a shift position of each segment area, and an increase in the processing amount of the CPU 21. For instance, if the surface area of a segment area increases by two times, the computation amount of the value Rsad increases by two times.

In view of the above, in the embodiment, the size of a segment area at a predetermined position is set large for reducing the computation amount while enhancing the distance detection precision.

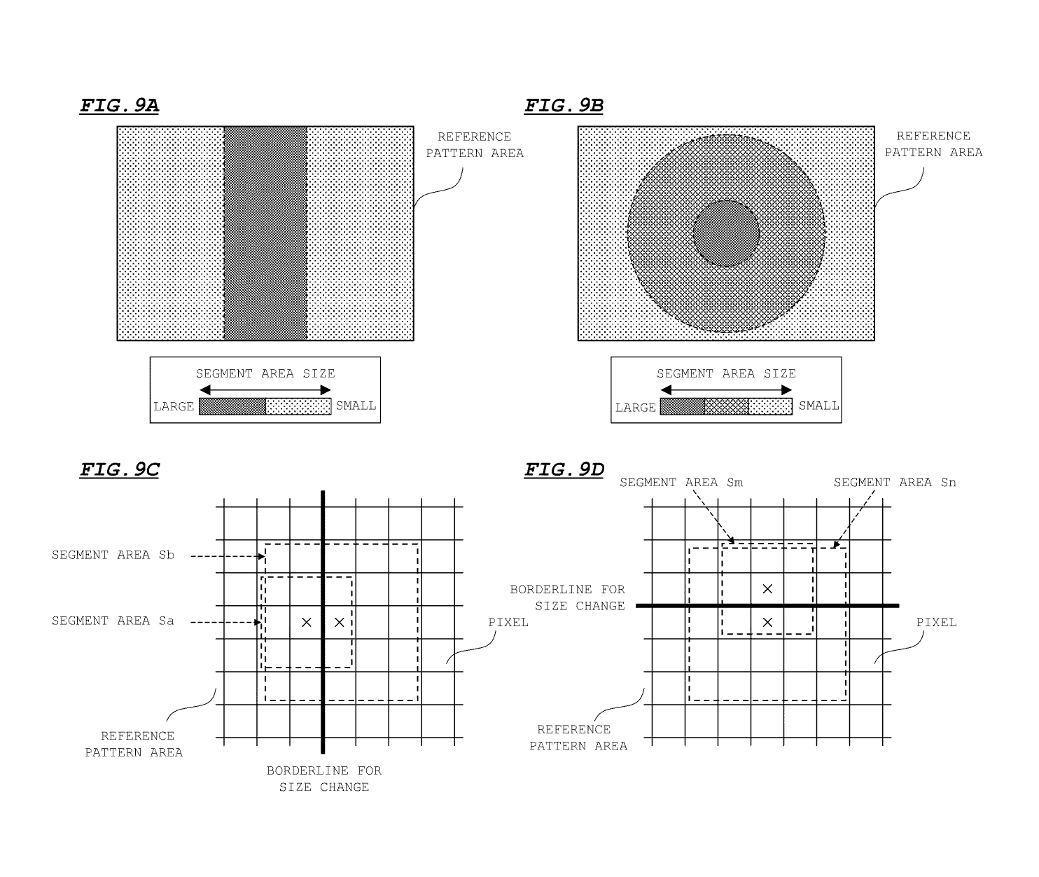

FIG. 9A is a schematic diagram showing the segment area size to be set for a reference pattern area in the embodiment.

As shown in FIG. 9A, segment areas are set in such a manner that the segment area size is set large in a vertically extending middle region of a reference pattern area and that the segment area size is set small in other region of the reference pattern area. By the above setting, it is possible to enhance the distance detection precision for a vertically extending middle region of a target area, and to suppress the processing amount for other region of the target area.

If the segment area size is set as described above, it is possible to accurately detect a person standing in the middle of a target area, in the case where the object detecting device is frequently used in a scene requiring detection of a person standing in the middle of the target area. Further, since the segment area size is set small in left and right ends of the target area, it is possible to suppress the processing amount of the CPU 21, although the detection precision may be slightly lowered.

Accordingly, the effects of the invention are advantageously obtained by setting the segment area size large in a region requiring enhanced distance detection precision, or by setting the segment area size small in a region in which enhanced distance detection precision is not required. The segment area size may be set to any value, as far as the aforementioned effects can be obtained. For instance, in FIG. 9A, the segment area size in the vertically extending middle region is set to 15 pixels by 15 pixels, and the segment area size in other region is set to 7 pixels by 7 pixels.

Further, in the case where a region requiring enhanced distance detection precision is a middle portion of a target area, for instance, as shown in FIG. 9B, the segment area size is set large in a circular middle region of a reference pattern. In this arrangement, as shown in FIG. 9B, the segment area size may be stepwise changed in accordance with a distance from the middle portion of the reference pattern area.

In the embodiment, the position of each segment area on a reference pattern area is defined with respect to the position of the center of the each segment area. The center of each segment area coincides with the position of one of the pixels to be included in the reference pattern area. The center positions of segment areas adjacent to each other in up and down directions or in left and right directions are displaced from each other by one pixel in up and down directions or in left and right directions.

In a border region between regions where the segment area sizes differ from each other, as shown in FIG. 9C, for instance, if the center position (indicated by the symbol x in FIG. 9C) of one of the adjacent segment areas crosses over the borderline, the segment area size is changed. In the example shown in FIG. 9C, the borderline extends in up and down directions. As shown in FIG. 9C, for instance, in the case where a segment area Sa having the size of 3 pixels by 3 pixels, and a segment area Sb having the size of 5 pixels by 5 pixels are adjacent to each other, if the center of one of the segment areas crosses over the borderline in left or right direction, the segment area size is changed from the size of 3 pixels by 3 pixels to the size of 5 pixels by 5 pixels. As shown in FIG. 9D, in the case where the borderline extends in left and right directions, if the center of one of the adjacent segment areas crosses over the borderline in up or down direction, the segment area size is changed. In the example of FIG. 9D, the size of a segment area Sm is 3 pixels by 3 pixels, and the size of a segment area Sn is 5 pixels by 5 pixels.

In the example shown in FIG. 9B, a borderline between the regions where the segment area sizes differ from each other does not have an arc shape but has a step-like shape formed by alternately connecting a vertical segment and a horizontal segment in terms of pixels. Similarly to the arrangements shown in FIGS. 9C and 9D, in the example shown in FIG. 9B, if the center of one of the adjacent segment areas crosses over the borderline in up or down direction, or in left or right direction, the segment area size is changed.

In the embodiment, the information for defining the position (center position of a segment area) and the size of a segment area is set for each of the segment areas, and is held in a reference template. Among the information, as described above, the information for defining the size is defined in such a manner that the segment area size is changed between the segment areas adjacent to each other with respect to a borderline.

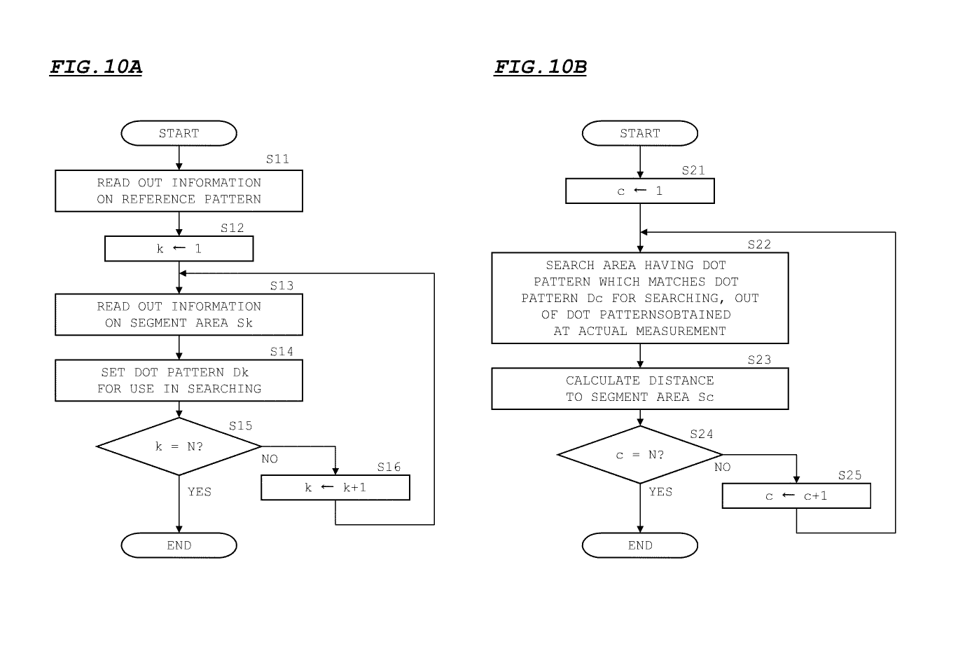

FIG. 10A is a flowchart showing a dot pattern setting processing for segment areas. The processing is performed when the information acquiring device 1 is activated or when distance detection is started. N segment areas are assigned to the reference pattern area, and the serial numbers from 1 to N are assigned to the segment areas. As described above, the position (center position of a segment area) and the size of each segment area on the reference pattern area are defined for each of the segment areas.

Firstly, the CPU 21 of the information acquiring device 1 reads out, from the reference template held in the memory 25, the information relating to the position of the reference pattern area on the CMOS image sensor 123, and the pixel values of all the pixels to be included in the reference pattern area (S11). Then, the CPU 11 sets “1” to the variable k (S12).

Then, the CPU 21 acquires, from the reference template held in the memory 25, the information relating to the size (height and width) of a k-th segment area Sk, and the information relating to the position of the segment area Sk (S13). Then, the CPU 21 sets a dot pattern Dk for use in searching, based on the pixel values of all the pixels to be included in the reference pattern area, and the information relating to the segment area Sk that has been acquired in S13 (S14). Specifically, the CPU 21 defines the segment area Sk in the reference pattern area, and acquires the pixel values of a dot pattern to be included in the segment area Sk, out of the pixel values of all the pixels in the reference pattern area, and sets the acquired pixel values as the dot pattern Dk for use in searching.

Then, the CPU 21 determines whether the value of k is equal to N (S15). In the case where the dot pattern for use in searching is set with respect to all the segment areas, and the value of k is equal to N (S15: YES), the processing is terminated. On the other hand, in the case where the value of k is smaller than N (S15: NO), the CPU 21 increments the value of k by one (S16), and returns the processing to S13. In this way, N dot patterns for use in searching are sequentially set.

FIG. 10B is a flowchart showing a distance detection processing to be performed at the time of actual measurement. The distance detection processing is performed, using the dot pattern for use in searching, which has been set by the processing shown in FIG. 10A, and is concurrently performed with the processing shown in FIG. 10A.

Firstly, the CPU 21 of the information acquiring device 1 sets “1” to the variable c (S21). Then, the CPU 21 searches an area having a dot pattern which matches a c-th dot pattern Dc for use in searching, which has been set in S14 in FIG. 10A, out of the dot patterns on the CMOS image sensor 123 obtained by receiving light at the time of actual measurement (S22). The searching operation is performed for an area having a predetermined width in left and right directions (X-axis direction) with respect to a position corresponding to the segment area Sc. If there is an area having a dot pattern which matches the dot pattern Dc for use in searching, the CPU 21 detects a moving distance and a moving direction (right direction or left direction) of the area having the matched dot pattern, with respect to the position of the segment area Sc, and calculates a distance of an object located in the segment area Sc, using the detected moving direction and moving distance, based on a triangulation method (S23).

Then, the CPU 21 determines whether the value of c is equal to N (S24). Distance calculation is performed for all the segment areas, and if the value of c is equal to N (S24: YES), the processing is terminated. On the other hand, if the value of c is smaller than N (S24: NO), the CPU 21 increments the value of c by one (S25), and returns the processing to S22. In this way, a distance to an object to be detected, which corresponds to a segment area, is obtained.

As described above, in the embodiment, as shown in FIGS. 9A and 9B, the segment area size is set large in a region requiring enhanced distance detection precision, and the segment area size is set small in other region. With this arrangement, it is possible to enhance the distance detection precision for an object to be detected, and to suppress the processing amount of the CPU 21.

The embodiment of the invention has been described as above. The invention is not limited to the foregoing embodiment, and the embodiment of the invention may be changed or modified in various ways other than the above.

For instance, in the embodiment, the CMOS image sensor 123 is used as a photodetector. Alternatively, a CCD image sensor may be used in place of the CMOS image sensor.

Further, in the embodiment, the laser light source 111 and the collimator lens 112 are aligned in X-axis direction, and the rise-up mirror 113 is formed to bend the optical axis of laser light in Z-axis direction. Alternatively, the laser light source 111 may be disposed in such a manner as to emit laser light in Z-axis direction; and the laser light source 111, the collimator lens 112, and the DOE 114 are aligned in Z-axis direction. In the modification, although the rise-up mirror 113 can be omitted, the size of the projection optical system 11 increases in Z-axis direction.

Further, in the embodiment, as shown in FIGS. 9A and 9B, the segment area size is set in advance for a reference pattern area. Alternatively, the segment area size may be set, as necessary, based on a detected distance to an object to be detected in a target area.

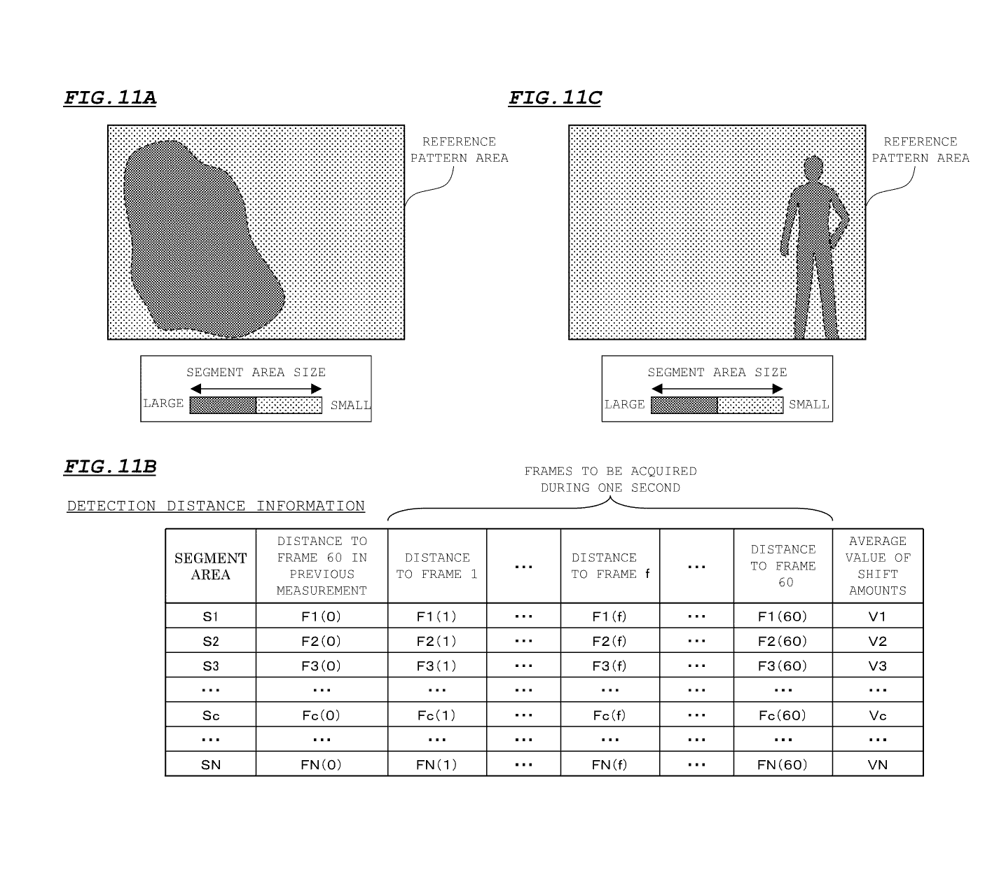

FIG. 11A is a schematic diagram showing segment area sizes, in the case where the segment area size is set large in a region where a change in the detection distance is large. As shown in FIG. 11A, in the case where it is judged that a moving amount of an object to be detected is large (a change in the detection distance is large) in a left-side region of a reference pattern area, as a result of distance detection, the segment area size in the region is set large.

The reference template holds therein two sizes i.e. a large size and a small size, as the segment area sizes (heights and widths). At the time of starting measurement, the size of all the segment areas is set to the small size. Thereafter, when a portion having a large moving amount of an object to be detected is detected, the size of a segment area corresponding to the portion is changed to the large size. If the moving amount in the portion decreases, the size of a segment area corresponding to the portion is returned to the small size.

FIG. 11B is a diagram schematically showing detection distance information for use in determining a moving amount of an object to be detected. The detection distance information is stored in the memory 25.

The memory 25 stores therein, as the detection distance information, a distance to be acquired by the processing shown in FIG. 10B, each time an image (frame) is captured by the CMO image sensor 123 every 1/60 second, sixty times. In other words, distances Fc(1) through Fc(60) with respect to a segment area Sc are stored during one second. Further, the detection distance information includes a distance Fc(0) of the frame 60 acquired at the previous measurement. Immediately after the information acquiring device 1 is activated, the value of the distance to the frame 60 in the previous measurement is set to e.g. zero.

After the distances to the frames 1 through 60 are acquired, an average value of shift amounts is acquired, based on the distance of the frame 60 at the previous measurement, and the distances to the frames 1 through 60. Specifically, firstly, a sum of shift amounts with respect to the segment area Sc is obtained by {Fc(1)-Fc(0)}+{Fc(2)-Fc(1)}+{(Fc(3)-Fc(2)}+ . . . +{(F(60)-F(59)}. An average value Vc of shift amounts is acquired by dividing the sum of shift amounts by 60. Then, it is determined that a segment area whose shift amount average value is equal to or larger than a predetermined value, out of the thus obtained average values of shift amounts of each segment area, is a segment area having a large change in the detection distance.

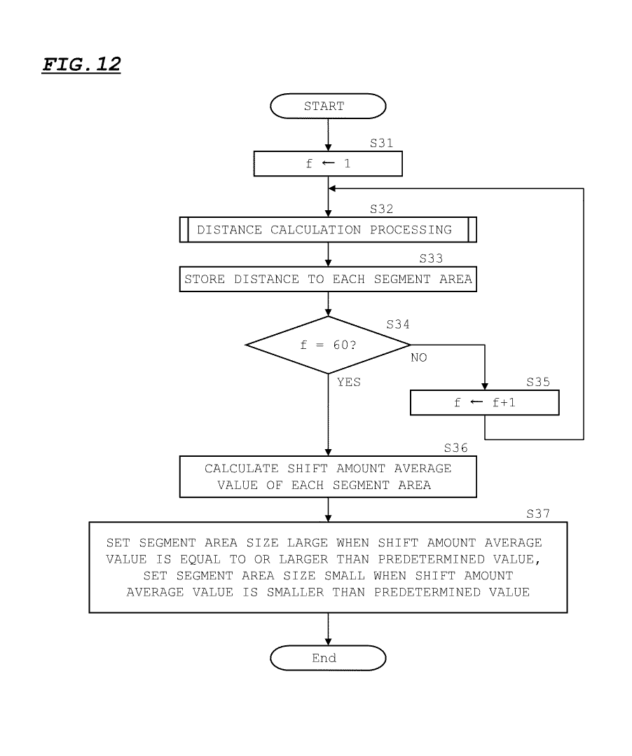

FIG. 12 is a flowchart showing a segment area re-setting processing to be performed in the above arrangement. In this example, similarly to the arrangement shown in FIG. 11B, distance measurement is performed every 1/60 second.

Firstly, the CPU 21 of the information acquiring device 1 sets 1 to the variable f (S31). Then, the CPU 21 calculates a distance to an object to be detected corresponding to each segment area in accordance with the processing shown in FIG. 10B (S32). The CPU 21 describes, in the detection distance information stored in the memory 25, the distance to the object with respect to each segment area, which has been obtained in S32, as corresponding to the value of the variable f (S33). For instance, in the case where the value of the variable f is 1, F1(1) through FN(1) are described in the detection distance information shown in FIG. 11B. Regarding a segment area for which distance information could not be obtained (distance measurement failed), the distance stored for the segment area in the previous measurement (in the previous measurement, the value of the variable f is smaller than the current value by one) is stored.

Then, the CPU 21 determines whether the value of the variable f is equal to 60 (S34). In the case where the value of the variable f is smaller than 60 (S34: NO), the CPU 21 increments the value of the variable f by one (S35), and returns the processing to S32. On the other hand, in the case where the value of the variable f is equal to 60, as a result of repeating the distance calculation (S34: YES), the processing is proceeded to S36.

In the case where the determination result in S34 is affirmative, as described above referring to FIG. 11B, average values V1 through VN of shift amounts of each segment area are calculated (S36). Then, the CPU 21 sets the size of a segment area whose shift amount average value is equal to or larger than a predetermined value to a large size, and sets the size of a segment area whose shift amount average value is smaller than the predetermined value to a small size, out of the average values V1 through VN of shift amounts (S37). The above setting is performed by applying either one of the two segment area sizes (heights and widths), which are held in the reference template. For instance, the size of a segment area whose shift amount average value is equal to or larger than the predetermined value is set to 15 pixels by 15 pixels, and the size of a segment area whose shift amount average value is smaller than the predetermined value is set to 7 pixels by 7 pixels.

As described above, by repeating the segment area re-setting processing (S31 through S37), it is possible to enhance the distance detection precision for an object to be detected whose moving amount is large, and to suppress the processing amount of the CPU 21.

In the processing shown in FIG. 12, the segment area size is switched between two sizes. Alternatively, the segment area size may be switched between three or more sizes depending on the magnitude of a shift amount average value. Further alternatively, other value representing a shift amount, such as a sum of shift amounts for a predetermined period, may be used, other than the shift amount average value.

Further, as shown in FIG. 11C, in the case where it is determined that there is a person in a target area, as a result of distance detection, the size of a segment area corresponding to a region presumably including a person may be set large, and the size of a segment area corresponding to other region may be set small.

Further, in the embodiment and the modification example, the segment area size is set to stepwise change. Alternatively, the segment area size may be set to linearly change.

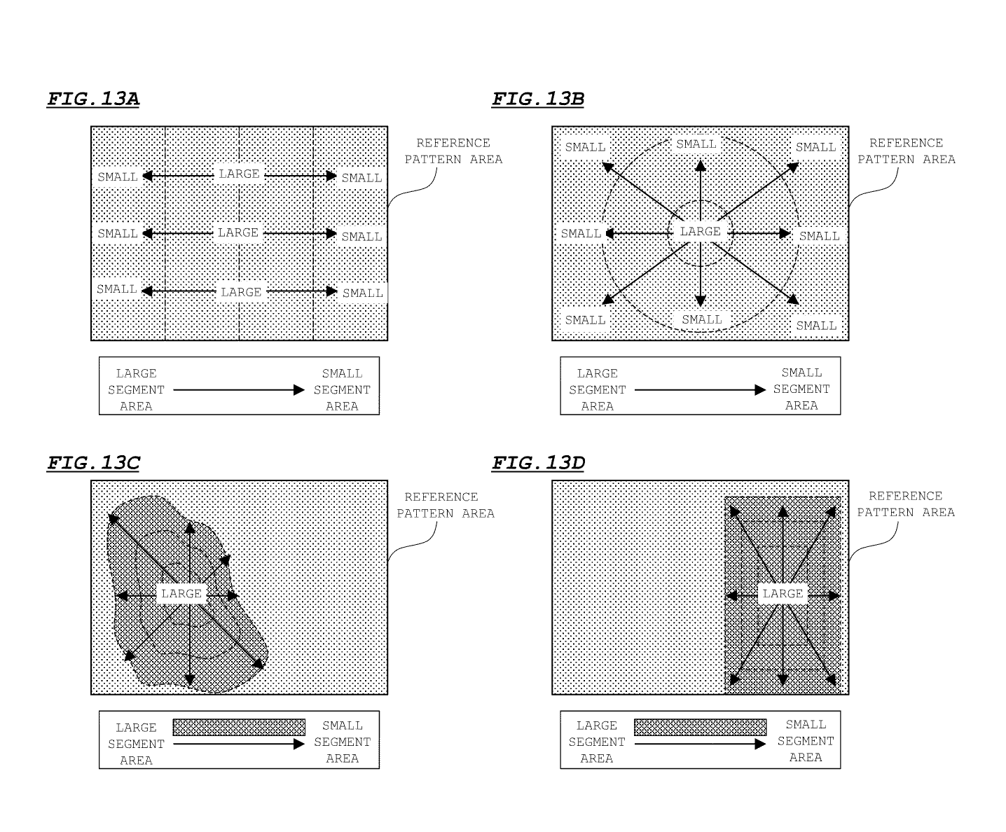

For instance, in place of the arrangement shown in FIG. 9A, as shown in FIG. 13A, the segment area size in a horizontally extending middle portion of a reference pattern area may be set to be largest; and the segment area size may be set to decrease, as the position of the segment area is shifted toward a left end portion or a right end portion of the reference pattern area. Further alternatively, in place of the arrangement shown in FIG. 9B, as shown in FIG. 13B, segment area sizes may be set in such a manner that the segment area size is largest at a center of a reference pattern area, and that the segment area size decreases, as the position of the segment area is shifted concentrically away from the center.

Further alternatively, in place of the arrangement shown in FIG. 11A, as shown in FIG. 13C, the segment area size may be set to linearly change, as the shift amount average value increases or decreases. Further alternatively, in place of the arrangement shown in FIG. 11C, as shown in FIG. 13D, in the case where it is determined that there is a person in a target area, the segment area size may be set to decrease in the vicinity of a region presumably including the person, as the position of the segment area is shifted from the center of the region toward an end portion of the region.

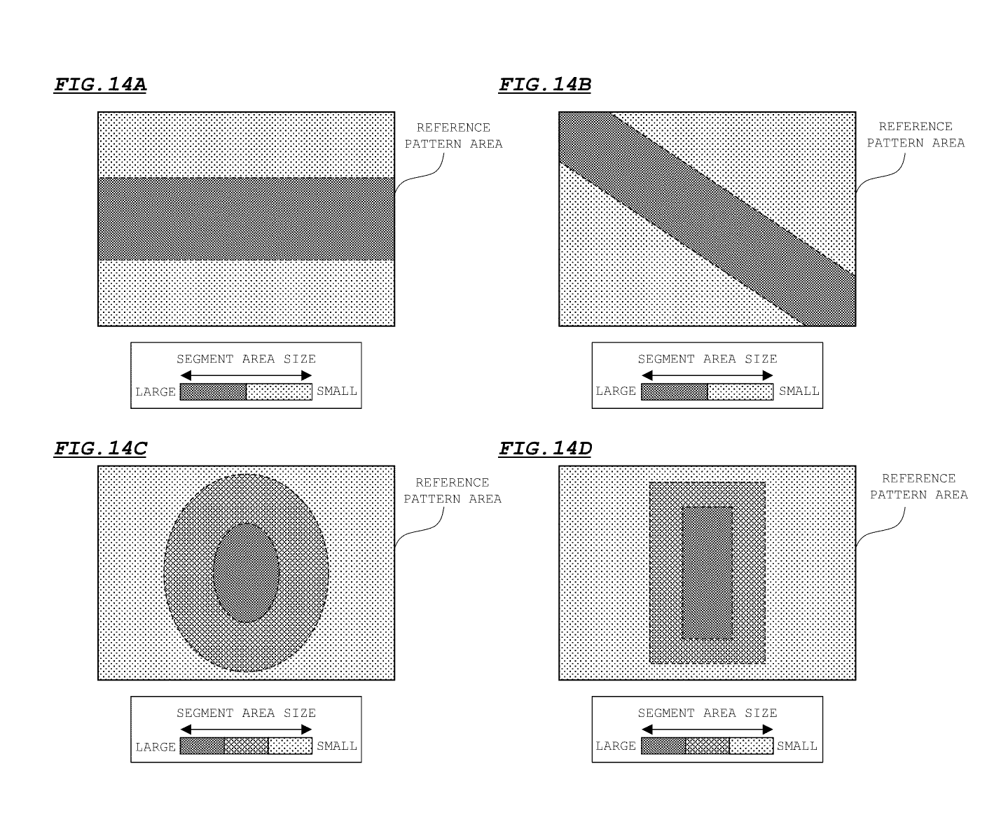

Further, in the embodiment, as shown in FIG. 9A, in the case where enhanced distance detection precision is required for a horizontally extending middle portion of a target area, the segment area size is set to be large in a vertically extending middle region of a reference pattern area. Alternatively, in the case where enhanced distance detection precision is required for a vertically extending middle portion or a diagonally extending region of a target area, as shown in FIG. 14A or FIG. 14B, the segment area size may be set to be large in a vertically extending middle portion or a diagonally extending region of a reference pattern area.

Further, in the case where enhanced distance detection precision is required for a middle portion of a target area, in the example shown in FIG. 9B, the segment area size is set to be large in a circular middle region of a reference pattern area. Alternatively, in the case where it is frequently the case that an object to be detected which is located in a middle portion of a target area has a predetermined shape, a region having a large segment area size may be set depending on the shape of the object to be detected. For instance, in the case where an object to be detected has an elliptical shape with a vertically long size, as shown in FIG. 14C, the segment area size may be set to stepwise decrease, as the position of the segment area is shifted elliptically away from the center. Further, in the case where an object to be detected has a rectangular shape with a vertically long size, as shown in FIG. 14D, the segment area size may be set to stepwise decrease, as the position of the segment area is shifted in a rectangular shape with a vertically long size away from the center.

Further, in the embodiment, as shown in FIG. 6C, each two segment areas are set to overlap each other in a state that the segment areas are displaced from each other by one pixel. Alternatively, each two segment areas may be set to overlap each other in a state that the segment areas are displaced from each other by plural pixels. Further alternatively, each two segment areas may be set to overlap each other only in one of left and right directions, and up and down directions; or segment areas adjacent to each other may be set not to overlap each other at all.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a projection optical system which projects laser light onto the target area with a predetermined dot pattern;
a light receiving optical system which is aligned with the projection optical system away from the projection optical system by a predetermined distance, and captures an image of the target area; and
a distance acquiring section which acquires a distance to each portion of an object in the target area, based on the dot pattern captured by the light receiving optical system, wherein
the distance acquiring section sets segment areas in a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area,
sizes of the segment areas are set in such a manner that the segment area sizes differ depending on regions of the reference dot pattern, and
the distance acquiring section acquires a degree of change in the distance to the target area at each measurement position of the target area at a time of actual measurement, and sets the segment area sizes in such a manner that the segment area size corresponding to a measurement position where the degree of change in the distance is equal to or larger than a predetermined threshold value is set larger than the segment area size corresponding to a measurement position where the degree of change in the distance is smaller than the predetermined threshold value.

2. The information acquiring device according to claim 1, wherein
the projection optical system includes:
a laser light source;
a collimator lens to which laser light emitted from the laser light source is entered; and
a diffractive optical element which converts the laser light transmitted through the collimator lens into light having a dot pattern by diffraction, and
the light receiving optical system includes:
an image sensor;
a condensing lens which condenses the laser light from the target area on the image sensor; and
a filter which extracts light of a wavelength band of the laser light for guiding the light to the image sensor.

3. An object detecting device, comprising:
an information acquiring device which acquires information on a target area using light,
the information acquiring device including:
a projection optical system which projects laser light onto the target area with a predetermined dot pattern;
a light receiving optical system which is aligned with the projection optical system away from the projection optical system by a predetermined distance, and captures an image of the target area; and
a distance acquiring section which acquires a distance to each portion of an object in the target area, based on the dot pattern captured by the light receiving optical system, wherein
the distance acquiring section sets segment areas in a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area,
sizes of the segment areas are set in such a manner that the segment area sizes differ depending on regions of the reference dot pattern, and
the distance acquiring section acquires a degree of change in the distance to the target area at each measurement position of the target area at a time of actual measurement, and sets the segment area sizes in such a manner that the segment area size corresponding to a measurement position where the degree of change in the distance is equal to or larger than a predetermined threshold value is set larger than the segment area size corresponding to a measurement position where the degree of change in the distance is smaller than the predetermined threshold value.

4. The object detecting device according to claim 3, wherein
the projection optical system includes:
a laser light source;
a collimator lens to which laser light emitted from the laser light source is entered; and
a diffractive optical element which converts the laser light transmitted through the collimator lens into light having a dot pattern by diffraction, and
the light receiving optical system includes:
an image sensor;
a condensing lens which condenses the laser light from the target area on the image sensor; and
a filter which extracts light of a wavelength band of the laser light for guiding the light to the image sensor.
